(19) United States
(12) Patent Application Publication
(10) Pub. No.: US 2015/0371498 A1
(43) Pub. Date: Dec. 24, 2015

(54) METHODS OF ADMINISTERING BLACKJACK GAMES WITH SIDE BETS AND RELATED APPARATUSES AND SYSTEMS

(71) Applicant: Bally Gaming, Inc., Las Vegas, NV (US)

(72) Inventor: Roger M. Snow, Las Vegas, NV (US)

(21) Appl. No.: 14/312,292

(22) Filed: Jun. 23, 2014

(51) Int. Cl. G07F 17/32; A63F 1/00

(52) U.S. Cl. CPC G07F 17/3244; A63F 1/00; G07F 17/3286; A63F 2001/003

(57) ABSTRACT

Methods of administering games of Blackjack may include accepting a first wager from a player. A second wager may be accepted from the player. Two cards may be dealt to Player hand and a Dealer hand. A decision to stand or a request to deal at least one additional card to the Player hand may be accepted from the player. The dealer may stand or deal additional cards to the Dealer hand according to house rules. The second wager may be resolved by determining whether the Player hand is a Blackjack. When the player holds a Blackjack, a payout may be paid to the player, an amount of the payout depending on a number of cards dealt to the Dealer hand. The first wager may be resolved by comparing a rank of the Player to the rank of the Dealer hand.

### FIELD

This disclosure relates generally to methods of administering wagering games for casinos and other gaming establishments, and related systems and apparatuses. More specifically, disclosed embodiments relate to methods of administering Blackjack games in which a side wager may be accepted and a payout on the side wager may be paid when a blackjack is dealt.

### BACKGROUND

Blackjack is a popular wagering game played in casinos and other gaming establishments. Some variants of blackjack and side bets for blackjack have been developed including, for example, Royal Match 21, Bet The Set “21,” King's Bounty, House Money^{SM}, and Straight Jack. Avid players are generally open to, and sometimes specifically seek out, new and more interesting ways to play blackjack, particularly when the reward for a winning outcome at the end of a round of play, or the odds of achieving a winning outcome, may be enhanced. For example, U.S. Pat. No. 8,459,650, issued Jun. 11, 2013, to Baseel, discloses a blackjack side bet in which a player wins when a rank of the dealer's hand exceeds twenty-one (i.e., the dealer busts).

A known variant to Blackjack is “5 Card Charlie”. With this variant, if the player receives 5 cards in their hand without exceeding a count of “21” according to the rules of Blackjack, their hand is an automatic winner of their base game wager. There are also related versions of 6, 7, 8 and 9 Card Charlies. No side wager is required to participate in the 5 Card Charlie variant.

### BRIEF SUMMARY

In some embodiments, methods of administering games of blackjack may involve accepting a first wager from a player by receiving a first physical, monetarily valuable wagering element in a first designated area on a surface of a gaming table. An optional second wager may be accepted from the player by receiving a second physical, monetarily valuable wagering element in a second designated area on a surface of a gaming table, the second designated area being separate and distinct from the first designated area. Two randomized physical cards from a deck of playing cards may be dealt to each of the Player hand and a Dealer hand. A decision to stand may be accepted from the player, in response to which no additional cards are dealt to the Player hand, or a request from the player to deal at least one additional card to the Player hand may be accepted, in response to which at least one additional card is dealt from the deck to the player to complete the Player hand. The dealer may stand or deal additional cards from the deck to the Dealer hand according to house rules. The first wager is resolved as between the Player hand and the Dealer hand according to the rules of Blackjack. The second wager may be resolved by determining whether the (a) Player hand is a Blackjack according to the rules of Blackjack and (b) based upon the number of cards in the Dealer's hand. A payout on the second wager may be paid to the player by physically transferring wagering elements to the player, an amount of the payout depending on a number of cards dealt to the Dealer hand. The first wager may be resolved by comparing a rank of a hand of the player to a rank of a hand of the dealer.

In other embodiments, methods of administering games of Blackjack may involve accepting an ante wager from a player by receiving a physical, monetarily valuable wagering element in a designated area on a surface of a gaming table. A mandatory side wager may be accepted from the player by receiving another physical, monetarily valuable wagering element in another designated area on a surface of a gaming table, the designated areas being separate and distinct from one another. Two randomized physical cards from a deck of playing cards may be dealt to each of a Player hand and a Dealer hand. To complete the Player hand a decision to stand may be accepted from the player, in response to which no additional cards are dealt to the Player hand, or a request by the player to deal at least one additional card to the Player hand may be accepted, in response to which at least one additional card is dealt from the deck to the Player hand. The dealer may stand or deal additional cards from the deck to the Dealer hand according to house rules. The ante wager is resolved by comparing the Player hand and the Dealer hand according to the rules of the game. The side wager may be resolved by determining (a) whether the player holds a Blackjack according to the rules of Blackjack and (b) the number of cards in the Dealer hand. A payout on the side wager may be paid to the player physically transferring wagering elements to the player, an amount of the payout increasing based upon the number of cards dealt to the Dealer hand.

In still other embodiments, methods of administering Blackjack games over networks may involve receiving at a user interaction service operated by a server comprising a processor authorization from a player to allocate funds to an ante wager. The user interaction service may receive authorization from the player to allocate funds to a side wager. A game service operated by the server may randomly assign rank and suit information correlating to two cards from a deck of playing cards to a Player hand. The user interaction service may receive instructions from the player not to allocate additional cards to the Player hand, in response to which the game service does not assign rank and suit information correlating to any additional cards to the Player hand, or to allocate at least one additional card to complete the Player hand, in response to which the game service randomly assigns rank and suit information correlating to at least one additional card from the deck to the Player hand. The game service may randomly assign rank and suit information correlating to two cards from the deck to a Dealer hand and apply house rules to stand or randomly assign rank and suit information correlating to additional cards from the deck to complete the Dealer hand. The side wager may be resolved by evaluating the Player hand at the game service to determine whether the Player hand is a Blackjack according to the rules of Blackjack. Responsive to a determination that the Player hand is a Blackjack, the game service may authorize payment of a payout to the player, an amount of the payout based upon the number of cards allocated to the Dealer hand. The ante wager may be resolved by comparing the Player hand to the Dealer hand at the game service according to the rules of the game.

### BRIEF DESCRIPTION OF THE DRAWINGS

While this disclosure concludes with claims particularly pointing out and distinctly claiming specific embodiments, various features and advantages of embodiments encompassed by this disclosure may be more readily ascertained from the following description when read in conjunction with the accompanying drawings, in which:

FIG. 1 is a flowchart diagram of a method of administering a wagering game, according to an embodiment of this disclosure;

FIG. 2 is a diagram of a playing surface for implementation of the wagering game, according to an embodiment of this disclosure;

FIG. 3 is an enlarged diagram of one of the player positions of the playing surface of FIG. 2;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a top view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual dealer;

FIG. 8 is a schematic block diagram of a gaming system for implementing embodiments of waging games in accordance with this disclosure;

FIG. 9 is a schematic block diagram of a gaming system for implementing embodiments of wagering games including a live dealer feed;

FIG. 10 is a block diagram of a computer for acting as a gaming system for implementing embodiments of wagering games in accordance with this disclosure; and

FIG. 11 is a schematic of a scratch card implementation of a wagering game in accordance with this disclosure.

### DETAILED DESCRIPTION

The illustrations presented herein are not meant to be actual views of any particular act in a method, apparatus, system, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games such as web-based games, casino games, card games, dice games, and other games, the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked” and “player-banked” configurations, which are described in more detail below) or in wagering games that involve no real-world monetary risks for the player (e.g., the “play-for-fun” and “social play-for-fun” configurations, which are described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local game, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer is described herein, and such description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

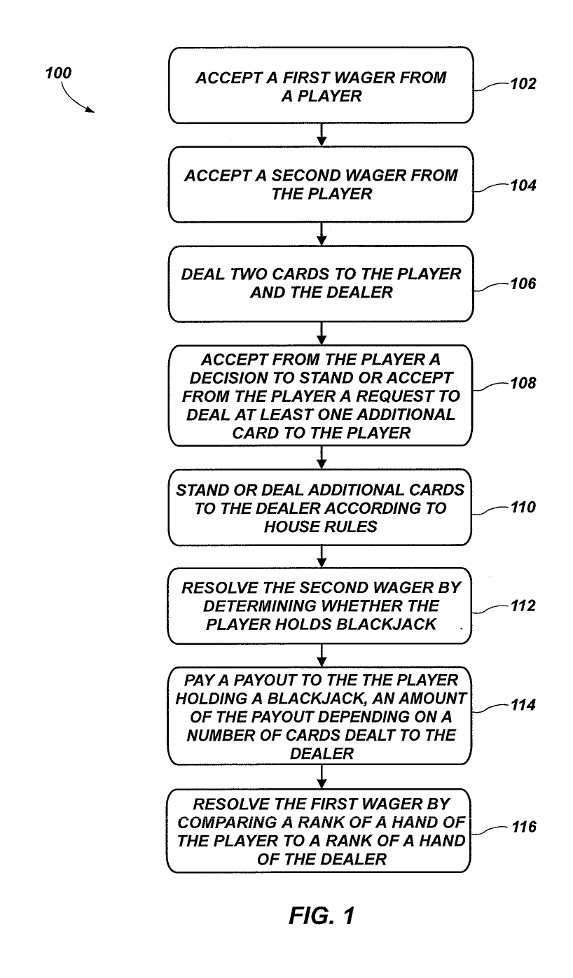

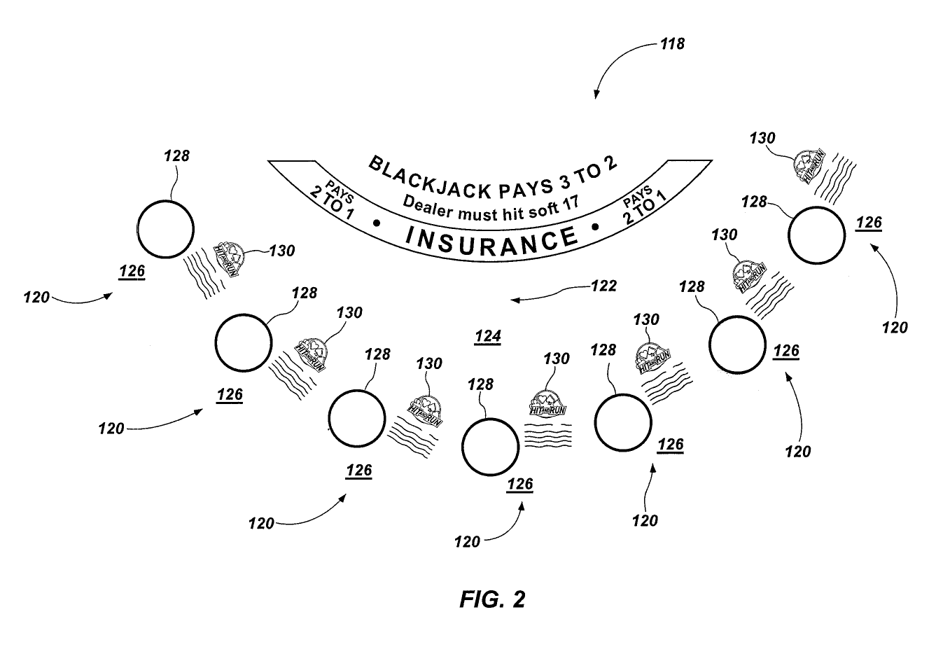

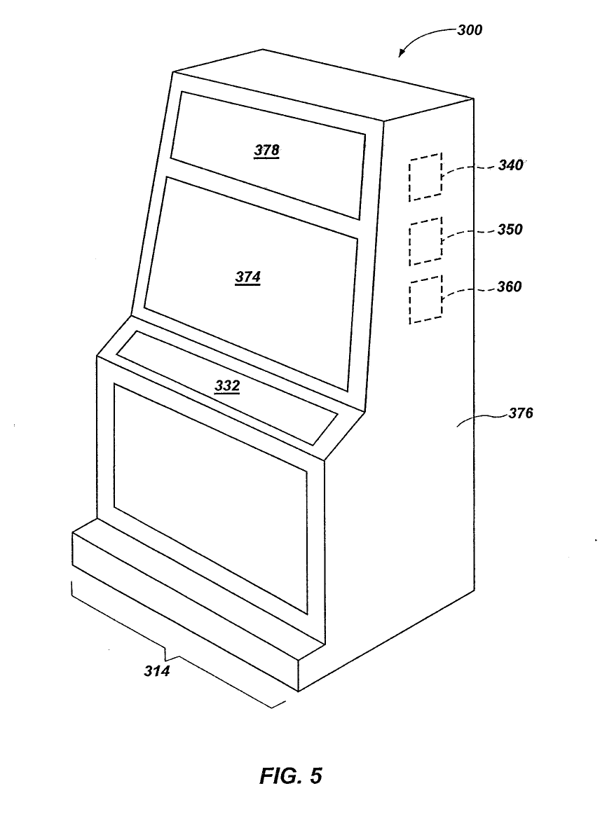

Referring to FIG. 1, a flowchart diagram of a method 100 of administering a wagering game is shown. More specifically, the method 100 may involve administering a base game of Blackjack with an optional or mandatory side bet feature. The game may include accepting a first wager from a player, as indicated at 102. The first wager may be, for example, an initial or ante wager which is required for players to participate in the game of Blackjack. The first wager may be a bet that a Player hand controlled by a respective player will outrank a Dealer hand controlled by the dealer without exceeding a rank of twenty-one according to the known scoring rules of Blackjack. The first wager may be accepted, for example, by physically receiving money or a representation of money (e.g., a chip or token) or by receiving electronic authorization to charge a player account (e.g., a credit account or a bank account). More specifically, the first wager may be accepted, for example, by physically receiving chips within a first wager position 128 on a playing surface 118 of a playing table 200, 400, or 500 (see FIGS. 2, 4, 6, and 7) or by receiving electronic authorization at a processor 350, 414, 428, 597, or 642 (see FIGS. 5 through 7 and 10) to charge a player account via a player interface 332, 416, 532, 624, or 644 (see FIGS. 5 through 8 and 10).

A second, side bet, wager may also be accepted from the player, as indicated at 104. The second wager may be, for example, a side wager that the first two cards dealt to the player will be a Blackjack according to the rules of Blackjack (i.e., an ace and a card ranked ten, such as a king, queen, jack, or ten). In some embodiments, the second wager may further include, for example, a bet that the first two cards dealt to the dealer will be a Blackjack. In some embodiments, the second wager may be a progressive wager. For example, the second wager may be allocated to a progressive pot, which may be maintained separate from the first wager. In some embodiments, the second wager may be an optional wager, such that the wagering game may be administered to players from whom the second wager is not accepted. In other embodiments, the second wager may be mandatory, such that the wagering game may only be administered to players from whom the second wager is accepted. The second wager may be accepted, for example, by performing any of the actions described previously in connection with acceptance of the first wager.

In some embodiments that involve allocating the second wager to a progressive pot, a rake may be taken on the progressive pot. The rake may be taken, for example, when the second wager is made or when a payout is paid or a distribution is made from the progressive pot. A quantity collected for the rake may be, for example, a fixed percentage of the second wager. More specifically, the percentage of the second wager collected for the rake may be, for example, greater than a theoretical house advantage for the underlying game. As another example, the rake may be less than an average house advantage for play of the wagering game by all players, including average and sub-average players, which may be calculated using a historical house advantage for the wagering game (e.g., a house advantage for the wagering game over the last 5, 10, or 15 years for a given casino or other gaming establishment). As specific, nonlimiting examples, the percentage of the second wager collected for the rake may be between 3% and 8%, between 4% and 7%, or between 5% and 6%. In other embodiments, the portion of the second wager collected for the rake may comprise a variable percentage of the second wager or may comprise a fixed quantity (e.g., a flat fee) irrespective of the total amount for the second wager, a fixed percentage with a cap, or a time-based fee for increments of time playing the wagering game.

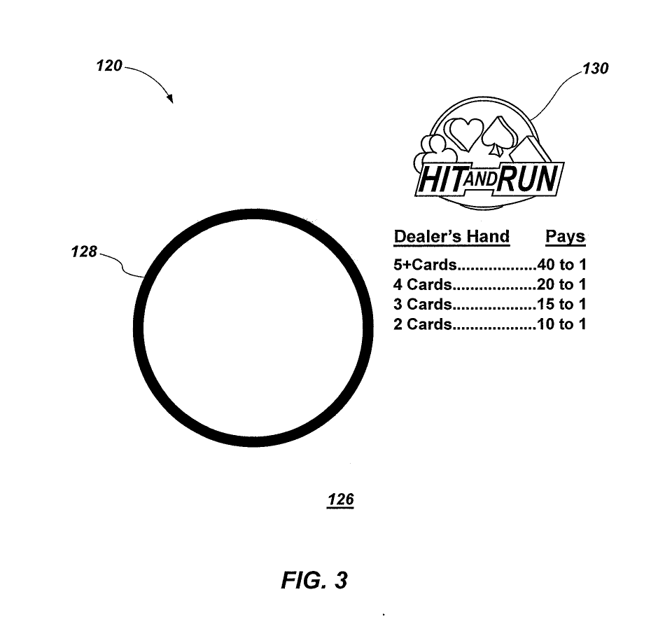

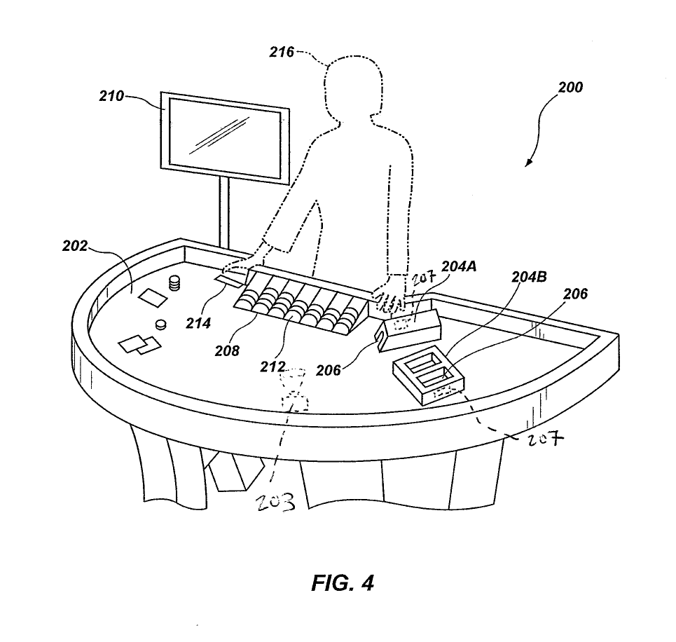

Two cards may be dealt to the Player hand and a Dealer hand, as indicated at 106. Two cards may also be dealt to each other participating player in the game of Blackjack. Dealing the cards to each Player hand and the Dealer hand may involve, for example, physically placing playing cards in each participating player position and a dealer position or electronically displaying rank and suit information (e.g., images, text, or both) of playing cards electronically assigned to each participating player position and a dealer position. More specifically, the cards may be dealt, for example, by physically distributing playing cards from a source of playing cards such as a deck or shoe within player card areas 126 (see FIGS. 2 and 3) in each participating player position 120 (see FIGS. 2 and 3) on a playing surface 118 (see FIG. 2) of a playing table 200, 400, or 500 (see FIGS. 4, 6, and 7), displaying electronic representations including rank and suit information for randomly generated playing cards on a screen or on screens 210, 332, 374, 404, 416, 430, 532, 560, 564, 622, 658, or 688 for each participating player (see FIGS. 4 through 7, 9, and 10), or electronically transmitting electronic information including rank and suit information for randomly generated playing cards to be displayed on a client screen or on screens 210, 332, 374, 416, 430, 532, 560, 564, 622, 658, or 688 for each participating player (see FIGS. 4 through 7, 9, and 10).

A decision to stand (i.e., not to add more cards to those already dealt) may be accepted from the player or a request to deal at least one additional card to the Player hand may be accepted from the player, as indicated at 108. The decision to stand may be accepted, for example, by sensing a verbal indication (e.g., a statement, such as “I stand.”) or a visual indication (e.g., a hand wave or tapping a finger near the cards) from a player and refraining from dealing additional cards or by receiving at a processor 350, 414, 428, 597, or 642 (see FIGS. 5 through 7 and 10) a signal indicative of the decision to stand entered by the player using a player interface 332, 416, 532, 624, or 644 (see FIGS. 5 through 8 and 10). A player's request for at least one additional card (i.e., an election to hit) may be accepted by performing any of the actions described in connection with accepting the player's decision to stand, with the exception that an additional card or additional cards are dealt to the player. In embodiments where multiple cards are dealt, multiple, successive elections to hit may be accepted. The card or cards may be dealt to the Player hand by performing any of the actions described previously in connection with dealing the first two cards.

The method 100 may further involve standing or dealing additional cards to the Dealer hand according to house rules, as indicated at 110. The house rules may dictate, for example, that the dealer is to stand when a cumulative rank of the cards dealt to the dealer is seventeen or higher and that the Dealer hand is to be dealt additional cards (i.e., to hit) when the cumulative rank of the cards dealt to the dealer is less than seventeen. In some embodiments, the house rules may dictate, for example, that the dealer is to stand when the Dealer hand holds a “soft” seventeen (i.e., a hand including an ace and ranked seventeen, wherein the ace is being counted as rank eleven, not rank one). In other embodiments, the house rules may dictate, for example, that the dealer is to hit when the Dealer hand holds a soft seventeen. The house rules may be applied, and cards may be dealt to the Dealer hand until the hand has been completed under the applicable rules of Blackjack, even in situations that might otherwise end the hand if standard Blackjack were being played. For example, when the player and dealer are the only participants in the game of Blackjack (i.e., are engaging in “heads-up” play) and the first two cards dealt to the Player hand are a Blackjack and a face up card in the dealer's hand is neither an ace nor a card ranked ten, the house rules may be applied to the dealer hand even though it would be impossible for the Dealer hand to outrank the player hand. As another example, when the player busts, the house rules may be applied to the Dealer hand even though it would be impossible for the player to win the first wager. The house rules may be applied, for example, by an in-person dealer recalling and carrying out memorized house rules, by an in-person dealer consulting a physical copy of the house rules (e.g., printed in a book or leaflet or on a table surface) and carrying them out, or by a processor 350, 414, 428, 597, or 642 (see FIGS. 5 through 7 and 10) accessing house rules stored in memory 340, 595, or 646 (see FIGS. 5, 7, and 10) and applying them.

When one or more additional cards are dealt to the Player or Dealer hands, the additional card or cards dealt may disqualify a hand held by the Player or Dealer from continued participation in at least the ante wager. For example, when the additional card or cards cause the rank of the Player hand or the Dealer to exceed twenty-one, the hand may be disqualified (i.e., may bust). When the Player hand is disqualified, the ante wager may, for example, be collected by the house. When the Dealer hand is disqualified, for example, a payout may be paid to the player.

The second wager may be resolved by determining whether the Player hand is a Blackjack, as indicated at 112. When the Player hand is a Blackjack, the player may win the second wager. Determining whether the Player hand holds a Blackjack may be accomplished by, for example, visually inspecting cards within player card areas 126 (see FIGS. 2 and 3) in each participating player position 120 (see FIGS. 2 and 3) on a playing surface 118 (see FIG. 2) of a playing table 200, 400, or 500 (see FIGS. 4, 6, and 7), electronically sensing (e.g., using a camera or an RFID sensor) rank and suit information of cards assigned to a player and interpreting the rank and suit information using a processor 350, 414, 428, 597, or 642 (see FIGS. 5 through 7 and 10), or accessing rank and suit information of cards assigned to a player in memory 340, 595, or 646 (see FIGS. 5, 7, and 10) and interpreting the rank and suit information using a processor 350, 414, 428, 597, or 642 (see FIGS. 5 through 7 and 10).

In some embodiments, the second wager may be further resolved by determining whether the Dealer holds a Blackjack. In such embodiments, players who placed the second wager for the round in which a Blackjack was dealt to the Dealer hand may win the second wager. Determining whether the Dealer hand holds a Blackjack may involve performing any of the actions described previously in connection with determining whether the Player hand holds a Blackjack, with the exception that the information pertaining to the Dealer hand is inspected, sensed, or accessed and interpreted.

When the Player hand holds a Blackjack, a payout on the second wager may be paid to the player, as indicated at 114. An amount of the payout may depend on a number of cards dealt to the Dealer hand. For example, the amount of the payout may increase as the number of cards in the Dealer hand increases. In some embodiments where the Dealer hand is a bust, the final card that caused the rank of the dealer's hand to exceed twenty-one may be included in the count of cards in the Dealer hand to increase the amount of the payout. In other embodiments where the Dealer hand is a bust, the final card that caused the rank of the dealer's hand to exceed twenty-one may be excluded in the count of cards in the Dealer hand to limit the amount of the payout. In some embodiments, the amount of the payout for holding a Blackjack may be, for example, according to the following pay table:

| Number of Cards Dealt | Payout for Holding |
|---|---|
| to the Dealer | Blackjack |
| Five or More | 40:1 |
| Four | 20:1 |
| Three | 15:1 |
| Two | 10:1 |

In embodiments where the second wager is a progressive wager placed into a progressive pot, the amount of the payout may further depend on the house rules for when the dealer is to hit and stand and on the number of card decks that have been grouped together, randomized, and provided for dealing cards. In some embodiments, all of the progressive pot may be paid to the player. In other embodiments, only a portion of the progressive pot may be paid to the player when the Player hand is a Blackjack the Dealer hand has a qualifying number of cards. For example, the entire progressive pot may only be paid to the player when the number of cards in the Dealer hand exceeds a certain number in some embodiments. In some embodiments, a portion of the progressive pot may be paid to the player(s) with the Blackjack and a remainder of the progressive pot, or a portion of that remainder, may be distributed among other players in the game. For example, each player participating in the game of Blackjack who made the second wager may be awarded a payout from the progressive pot, when any player who made the second wager is dealt a Blackjack and the Dealer hand qualifies. As another example, each player who made the second wager and is dealt a Blackjack may receive a payout from the progressive pot. As yet another example, each player participating in the game of Blackjack who made the second wager may win the second wager, and be awarded a payout from the progressive pot, when the number of cards in the Dealer hand is a certain number or greater, such as, for example, seven or more.

As a specific, nonlimiting example, the amount of a progressive payout paid from the progressive pot to a player controlling a Player hand holding a Blackjack may be according to the following paytable:

| | Two Decks— | Two Decks— | Six Decks— | Six Decks— |
|---|---|---|---|---|
| Number of | Dealer Hits | Dealer Stands | Dealer Hits | Dealer Stands |
| Cards Dealt to | on a Soft | on a Soft | on a Soft | on a Soft |
| the Dealer | Seventeen | Seventeen | Seventeen | Seventeen |
| Eight or More | 100% of | 100% of | 100% of | 100% of |
| | Progressive | Progressive | Progressive | Progressive |
| | Pot | Pot | Pot | Pot |
| Seven | 100:1 | 200:1 | 100:1 | 200:1 |
| Six | 25:1 | 25:1 | 25:1 | 25:1 |
| Five | 7:1 | 8:1 | 7:1 | 8:1 |
| Four or Fewer | Push | Push | Push | Push |
| Dealer | 4:1 | 4:1 | 4:1 | 4:1 |
| Blackjack | | | | |

Another illustrative paytable for payment amounts of progressive payouts paid from the progressive pot to a player holding a Blackjack may include the following:

| Number of Cards | Six Decks—Dealer Hits or |
|---|---|
| Dealt to the Dealer | Stands on a Soft Seventeen |
| Nine or More | 100% of Progressive Pot |
| Eight | 1,000:1 |
| Seven | 250:1 |
| Six | 25:1 |
| Five | 9:1 |
| Four or Fewer | Push |

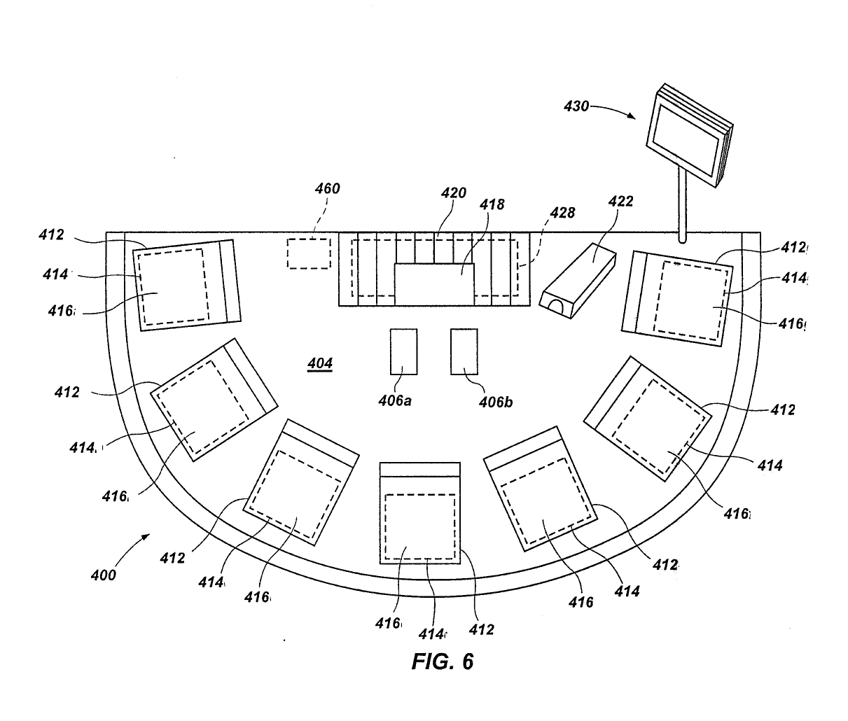

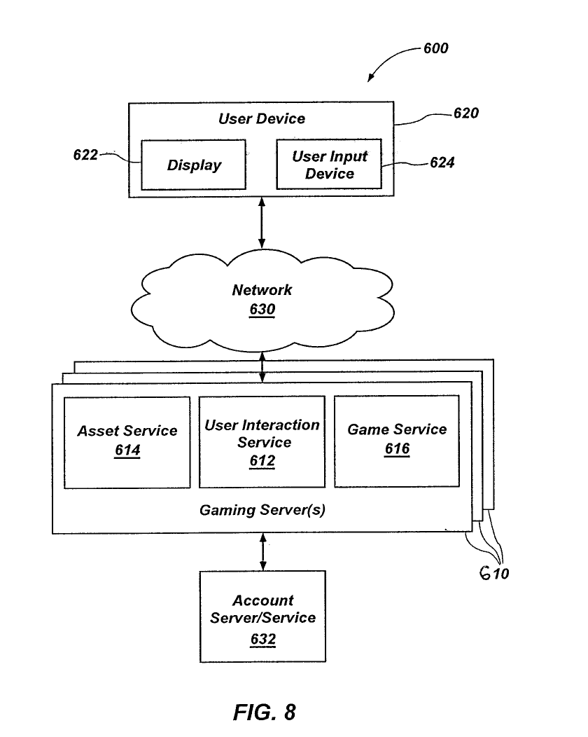

Paying the payout may involve, for example, physically giving money or chips or granting electronic authorization to transfer funds to a player account. More specifically, the payout may be paid, for example, by physically placing chips within a player position 120 (see FIGS. 2 and 3) on a playing surface 118 (see FIG. 2) of a playing table 200, 400, or 500 (see FIGS. 4, 6, and 7), by receiving electronic authorization at a processor 350, 414, 428, 597, or 642 (see FIGS. 5 through 7 and 10) via a dealer interface 418 (see FIG. 6) to transfer funds from an account server 632 (see FIG. 8) to a player account, or automatically generating electronic authorization at the processor 350, 414, 428, 597, or 642 (see FIGS. 5 through 7 and 10) to transfer funds from an account server 632 (see FIG. 8) to a player account.

In some embodiments, the amount of the second wager may be collected by the house when the Player hand does not hold a Blackjack or otherwise win the second wager. Collecting the amount of the second wager may be accomplished, for example, by physically retrieving money or chips or granting electronic authorization to transfer funds to a house account. More specifically, collecting the amount of the second wager may be accomplished, for example, by physically retrieving chips from the playing surface 118 (see FIG. 2) of a playing table 200, 400, and 500 (see FIGS. 4, 6, and 7), receiving electronic authorization at a processor 350, 414, 428, 597, or 642 (see FIGS. 5 through 7 and 10) via a dealer interface 418 (see FIG. 6) to transfer funds from a player account to an account server 632 (see FIG. 8), or automatically generating electronic authorization at the processor 350, 414, 428, 597, or 642 (see FIGS. 5 through 7 and 10) to transfer funds from the player account to the account server 632 (see FIG. 8).

In embodiments where the second wager is a progressive wager placed into a progressive pot, the amount of the second wager may be maintained in the progressive pot when the Player hand is not a Blackjack or otherwise win the second wager. Maintaining the amount of the second wager in the progressive pot may involve, for example, physically moving money or chips or allocating funds to a progressive pot account. More specifically, maintaining the amount of the second wager in the progressive pot may be accomplished by physically removing chips from the playing surface 118 (see FIG. 2) of a playing table 200, 400, or 500 (see FIGS. 4, 6, and 7) and entering their value into a meter for tracking the progressive pot via a dealer interface 418 (see FIG. 6), electronically sensing (e.g., using a camera or an RFID sensor) the value of chips allocated to the second wager and adding the value to a meter for tracking the progressive pot using a processor 350, 414, 428, 597, or 642 (see FIGS. 5 through 7 and 10), or automatically generating electronic authorization at the processor 350, 414, 428, 597, or 642 (see FIGS. 5 through 7 and 10) to transfer funds from an a player account to a progressive pot account.

The first wager may be resolved by comparing a rank of each Player hand to the rank of the Dealer hand, as indicated at 116. When the rank of the Player hand exceeds the rank of the Dealer hand, without exceeding twenty-one, the player may win the first wager and a payout may be paid to the player. When the rank of the Player hand is equal to the rank of the Dealer hand, without exceeding twenty-one, the first wager may be a push and an amount of the first wager may be returned to the player. When the rank of the Player hand is less than the rank of the Dealer hand, without exceeding twenty-one, the player may lose the first wager and an amount of the first wager may be collected by the house in some embodiments. Comparing the hands of the player and the dealer may involve, for example, visually inspecting cards allocated to the player and the dealer, electronically sensing cards allocated to the player and the dealer, accessing memory 340, 595, or 646 (see FIGS. 5, 7, and 10) in which rank and suit information for cards allocated to the player and dealer is stored, and mentally calculating or electronically calculating using a processor 350, 414, 428, 597, or 642 (see FIGS. 5 through 7 and 10) the ranks of the hands held by the player and the dealer. After the ranks are calculated, they may be compared mentally, using a chart, or electronically using a processor 350, 414, 428, 597, or 642 (see FIGS. 5 through 7 and 10).

Various platforms are contemplated that are suitable for implementation of embodiments of wagering games according to this disclosure. For example, embodiments of wagering games may be implemented as live table games with an in-person dealer, electronic gaming machines, partially or fully automated table games, and fully automated, network-administered games (e.g., Internet games) wherein game results may be produced utilizing a processor or a live video feed of a dealer administering a game from a remote studio.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally-authorized site on the Internet, or on a play-for-fun site on the Internet.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely-located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

Referring to FIG. 2, a diagram of a playing surface 118 for implementation of the wagering games within the scope of the present disclosure is shown. Such an implementation may be a felt layout on a physical gaming table 200, 400, or 500 (see FIGS. 4, 6, and 7) or an electronic representation on a video display 210, 332, 374, 404, 416, 430, 532, 560, 564, 622, 658, or 688 (see FIGS. 4 through 7, 9, and 10) for each participating player position 120. The playing surface 118 may include player positions 120 to receive the Player hands with which players may interact and a dealer position 122 to receive the Dealer hand and with which the dealer may interact and within each of which the activity (e.g., wagering and card dealing) may take place. The dealer position 122 may be, for example, an area 124 within which the Dealer hand may be dealt to the dealer.

Referring to FIG. 3, an enlarged diagram of one of the player positions of the playing surface 118 of FIG. 2 is shown. Each player position 120 may include an area 126 within which cards for each Player hand may be dealt to the player, a first wager position 128 within which chips may be placed when the first wager is accepted, and a second wager position 130 within which chips may be placed when the second wager is accepted.

The results of actions performed when administering wagering games in accordance with this disclosure may be reflected on the playing surface 118. For example, and referring collectively to FIGS. 2 and 3, the casino or other gaming establishment, acting as the dealer, may accept an ante wager from each player, which may be reflected by the presence of a chip or an image of a chip in the first wager position 128 in the player position 120 of each participating player. The dealer may also accept a side wager from at least one player, which may be reflected by the presence of a chip or an image of a chip in the second wager position 130.

The dealer may deal two cards to each Player hand and to the Dealer hand, which may be reflected by the presence of cards or images of cards in the area 126 of each player position 120 and in the area 124 of the dealer position 122. The dealer may accept from each player, in turn, a decision to stand or an election to hit. When the dealer accepts a player's decision to stand, the dealer may refrain from dealing additional cards to the area 126 of that player's player position 120. When the dealer accepts a player's election to hit, the dealer may deal an additional card to the area 126 of that player's player position 120, and may deal yet more cards to the area 126 of that player's player position 120 when the dealer accepts other, subsequent elections to hit.

The dealer may apply house rules to determine whether to stand or to deal additional cards to the area 124 of the dealer position 122. The house rules may require that the dealer stand, which may be reflected by the dealer refraining from dealing additional cards to the area 124 of the dealer position 122, or that the dealer hit, which may be reflected by the presence of additional cards or images of cards in the area 124 of the dealer position 122.

The dealer may resolve the second wager by determining whether any of the players who made the second wager holds a Blackjack. Each of the players who made the second wager and were dealt a Blackjack for their first two cards may be paid a payout, which may be reflected by the dealer placing chips in a respective player's player position 120 or authorizing transfer of funds to a respective player's account. The amount of the payout may depend on the number of cards in the Dealer hand, and may increase as the number of cards in the Dealer hand increases. The dealer may resolve the ante wager by comparing the rank of the Player's hand to the rank of the Dealer hand. Such “house-banked” embodiments may be implemented in the form of a live table game, in a virtual table game, in an electronic game, or in an online game configuration.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented, for example, in the form of a live table game, in a virtual table game, in an electronic game, or in a networked (e.g., Internet) game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, nonlimiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, paytables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204. The card-handling device 204A may be, for example, a shoe from which physical cards 206 from one or more decks of playing cards may be withdrawn, one at a time. Such a card-handling device 204A may include a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosure of which is incorporated herein in its entirety by this reference. The card-handling device 204B may be, for example, a shuffler configured to reorder physical cards 206 from one or more decks of playing cards and present randomized cards 206 for use in the wagering game. Such a card-handling device 204B may include a housing, a shuffling mechanism configured to shuffle cards, and card inputs and outputs (e.g., trays). Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. The card-handling device 204 may also be, for example, a combination shuffler and shoe in which the output for the shuffler is a shoe. The card-handling device 204 may simply be supported on the gaming surface 202 in some embodiments. In other embodiments, the card-handling device 204 may be mounted into the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, etc.

In some embodiments, the card-handling device 204 may include an electronic display 207 for displaying information related to the wagering game being administered. For example, the electronic display 207 may display a menu of game options, the game selected, the number of cards per hand to be dispensed, acceptable amounts for wagers (e.g., maximums and minimums), numbers of cards to be dealt to recipients, locations of particular recipients for particular cards, winning and losing wagers, pay tables, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific the game to be implemented. For example, the card-handling device 204 may be configured to support at least a physical deck of 52 standard playing cards. More specifically, the card-handling device 204 may be configured to support a physical deck including multiple sets (e.g., two, six, or eight sets) of the 52 standard playing cards. In some embodiments, additional cards may further be included in the deck, such as, for example, bonus cards (e.g., granting an automatic payout upon dealing and redemption or granting a prize or other award upon dealing and redemption) or wild cards (e.g., jokers). As a specific, nonlimiting example, the card-handling device 204 may be a shoe or a combination card shuffler and shoe configured to present cards (e.g., in groups or one at a time) from a deck including one or more sets of 52 standard playing cards and, optionally, one or more bonus cards.

The gaming table 200 may include one or more chip racks 208 configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art, and may be incorporated directly into the gaming table 200 and may, in some embodiments, have a removable container for the retrieval of money in a separate, secure location.

When administering a wagering game in accordance with embodiments of this disclosure, a dealer 216 may receive money (e.g., cash) from a player in exchange for wagering elements 212. The dealer 216 may deposit the money in the deposit 214 and transfer physical wagering elements 212 to the player. The dealer 216 may accept one or more initial wagers (e.g., antes and other wagers) from the player, which may be reflected by the dealer 216 permitting the player to place one or more wagering tokens 212 or other wagering elements (e.g., cash) within designated areas on the gaming surface 202 associated with the various wagers of the wagering game. Once initial wagers have been accepted, the dealer 216 may remove physical cards 206 from the card-handling device 204 and position them within designated areas on the gaming surface 202, which may designate the cards 206 for use as individual player cards, community cards, or dealer cards in accordance with game rules.

After dealing the cards 206, and during play, according to the game rules, any additional wagers (e.g., play bets) may be accepted, which may be reflected by the dealer 216 permitting the player to place one or more wagering tokens 212 within designated areas on the gaming surface 202 associated with the various wagers of the wagering game. In some embodiments, a player may fold, which may result in the dealer 216 collecting at least one of the wagering tokens 212 from that player and transferring it to the house, which may be reflected by the wagering token 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering tokens 212 from the chip rack 208 to the players, and transferring losing wagers to the house, which may be accomplished by moving wagering tokens 212 from the players to the chip rack 208.

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices, such as a server, through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING,” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc.) and accepting player elections. The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touch screen controls for receiving dealer inputs and assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to casino personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

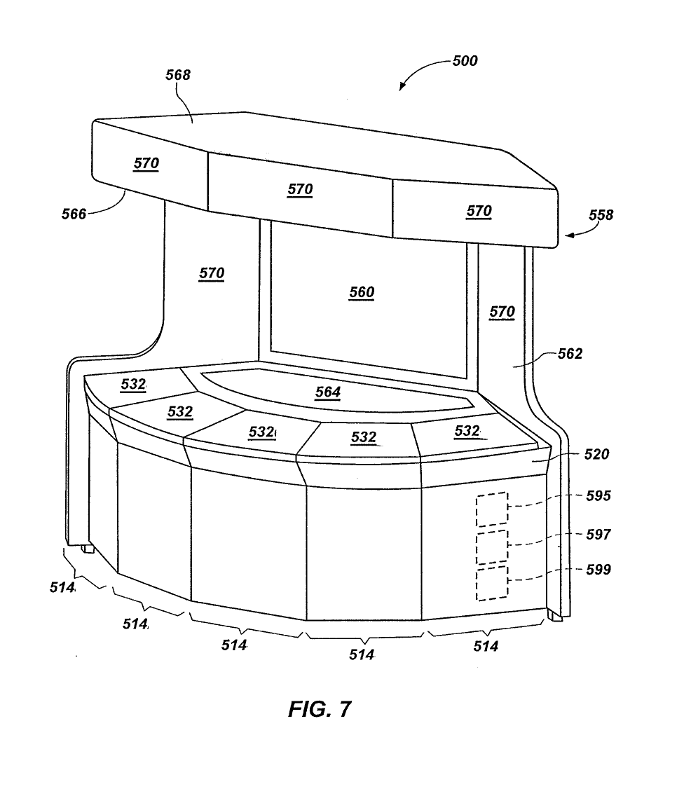

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices, such as a central server, through a suitable communication medium, such, as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

In some embodiments, wagering games in accordance with this disclosure may be administered using a gaming system employing a client-server architecture (e.g., over the Internet, a local area network, etc.). FIG. 8 is a schematic block diagram of an illustrative gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In some embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically, the user device is remote from the gaming server 610 and the network is the word-wide web (i.e., the Internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may, for example, access, interpret, and apply game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, nonlimiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

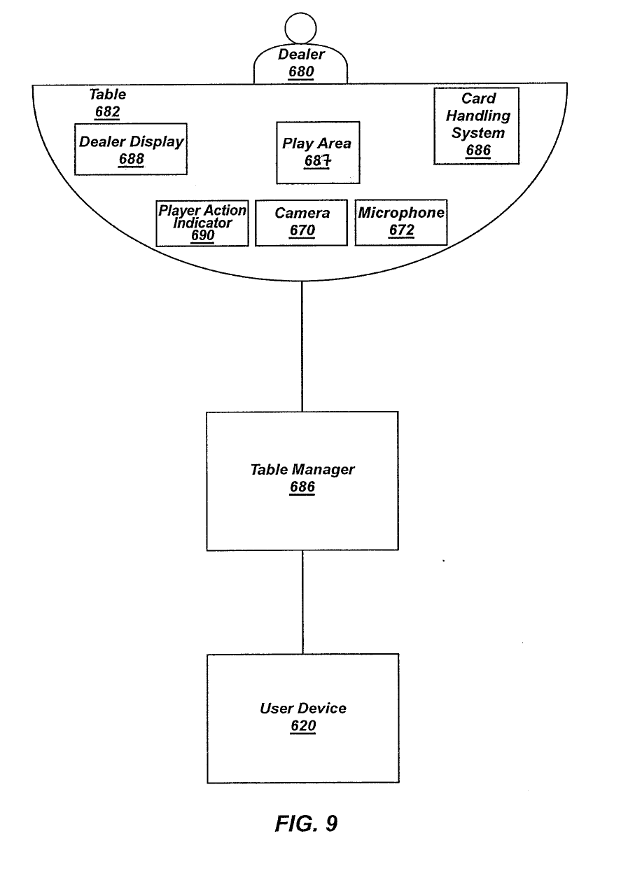

FIG. 9 is a schematic block diagram of a table 682 for implementing wagering games including a live dealer feed. Features of the gaming system 600 (see FIG. 8) described above in connection with FIG. 8 may be utilized in connection with this embodiment, except as further described. Rather than cards being determined by a computerized random processes, physical cards (e.g., from a standard, 52-card deck of playing cards) may be dealt by a live dealer 680 at a table 682 from a card handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example. Examples of card data include, for example, suit and rank information of a card, suit and rank information of each card in a hand, rank information of a hand, and rank information of every hand in a round of play

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players

The card handling system 684 may be as shown and described previously in connection with FIG. 4. The play area 686 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card handling system 684 to identify cards dealt by the card handling system 684. For example, the card handling system 684 may include a card reader to determine card information from the cards. The card information may include the rank and suit of each dealt card and hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example.

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

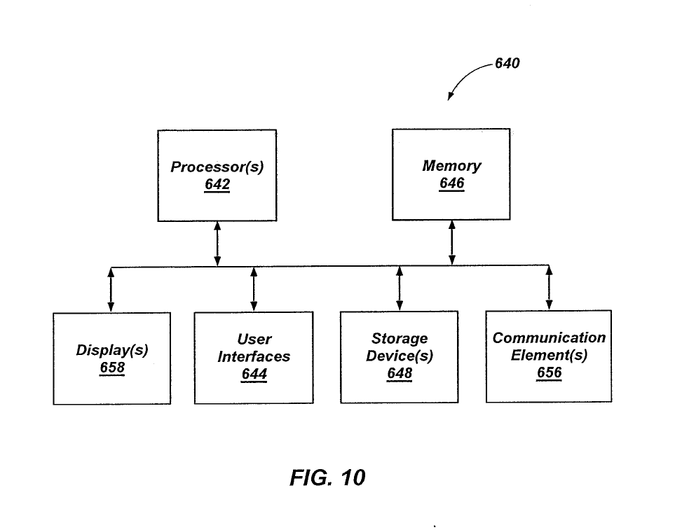

FIG. 10 is a simplified block diagram showing elements of computing devices that may be used in systems and apparatuses of this disclosure. The computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light emitting diode displays, liquid crystal displays, cathode ray tubes, and the like. In addition, the display 658 may be configured with a touch-screen feature for accepting user input as a user interface element 644.

As non-limiting examples, the user interface elements 644 may include elements such as displays, keyboards, push-buttons, mice, joysticks, haptic devices, microphones, speakers, cameras, and touchscreens.

As non-limiting examples, the communication elements 656 may be configured for communicating with other devices or communication networks. As non-limiting examples, the communication elements 656 may include elements for communicating on wired and wireless communication media, such as for example, serial ports, parallel ports, Ethernet connections, universal serial bus (USB) connections, IEEE 1394 (“firewire”) connections, Thunderbolt™ connections, Bluetooth® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one nonlimiting example, the memory 646 may be divided into cache memory, graphics memory, and main memory. Each of these memories may communicate directly or indirectly with the one or more processors 642 on separate buses, partially-combined buses, or a common bus.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given nonmonetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., the first and second wagers described previously in connection with FIG. 1) of no real-world monetary value, and payouts (e.g., the payouts on the first and second wagers described previously in connection with FIG. 1) may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

### Example

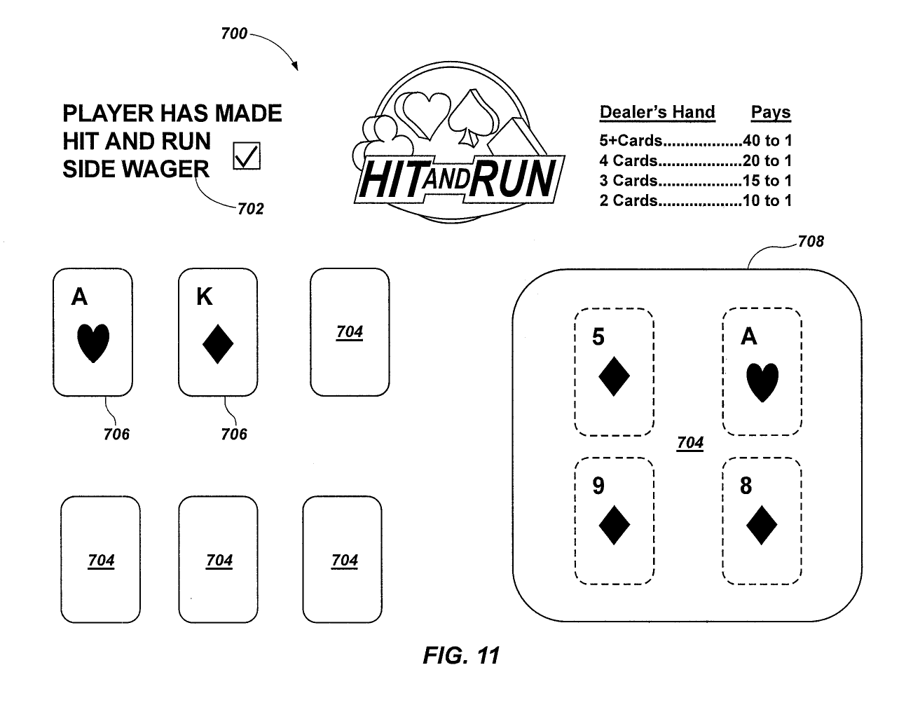

With reference to FIG. 11, a schematic 700 of a wagering game implemented as a scratch card is shown. An ante wager may be accepted from a player by accepting a first amount as payment for the scratch card. A side wager may be accepted from the player by accepting an increased amount in payment for the scratch card, and an indication 702 (e.g., checking a box) may be printed on the scratch card to verify that the side wager was accepted before giving the player the scratch card. The player may be given the scratch card, and the player may be dealt cards by accepting a redeemed card with at least two coverings 704 scratched off to reveal individual player cards 706. A player's decision to stand may be accepted when the card is redeemed with only two player cards 706 revealed. A player's decision to hit may be accepted when the player card is accepted with more than two player cards 706 revealed. The dealer may be dealt cards by accepting a redeemed card with a dealer hand 708 revealed by scratching off a covering 704. The ante wager may be resolved by visually comparing the player cards 706 to the Dealer hand 708 and determining whether the Player hand formed from the player cards 706 outranks the Dealer hand 708 without exceeding twenty-one or whether the dealer hand 708 is a bust. The side wager may be resolved by visually confirming that the side wager was made (e.g., verifying that the indication 702 is printed on the scratch card) and visually determining whether the player cards 706 are a Blackjack. When the player cards 706 are a Blackjack, a payout may be paid to the player. An amount of the payout may depend on a number of cards in the Dealer hand 708, such as by increasing the amount of the payout as the number of cards in the Dealer hand 708 increases.

While certain illustrative embodiments have been described in connection with the figures, those of ordinary skill in the art will recognize and appreciate that the scope of this disclosure is not limited to those embodiments explicitly shown and described herein. Rather, many additions, deletions, and modifications to the embodiments described herein result in embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

What is claimed is:

1. A method of administering a game of Blackjack including a side bet feature, comprising:
accepting a first wager from a player to participate in the Blackjack component of the game by receiving a first physical, monetarily valuable wagering element in a first designated area on a surface of a gaming table;
accepting an optional second wager from the player to play the side bet feature of the game by receiving a second physical, monetarily valuable wagering element in a second designated area on a surface of a gaming table, the second designated area being separate and distinct from the first designated area;
dealing two randomized physical cards from a deck of playing cards to each of a Player hand controlled by the player and a Dealer hand;
accepting from the player a decision to stand, in response to which no additional cards are dealt to the player, or accepting a request from the player to deal at least one additional card to the player, in response to which at least one additional card is dealt from the deck to the player for completion of a Player hand according to the rules of the game;
standing or dealing additional cards to the Dealer hand for completion of the Dealer hand according to house rules of the game;
resolving the first wager according to the rules of Blackjack; and
paying a payout on the second wager to the player when the Player hand is a Blackjack by physically transferring wagering elements to the player, an amount of the payout depending on a number of cards dealt to the dealer.

2. The method of claim 1, further comprising collecting an amount of the second wager when the Player hand is not a Blackjack.

3. The method of claim 1, further comprising allocating at least a portion of the second wager to a progressive pot when the player does not hold a Blackjack.

4. The method of claim 3, wherein paying the payout on the second wager comprises paying a portion of the progressive pot to the player holding a Blackjack and allocating a remainder of the progressive pot among other players from whom a second wager was accepted during a round of play resulting in the player holding a Blackjack.

5. The method of claim 4, wherein paying the portion of the progressive pot to the player and allocating the remainder of the progressive pot among others players from whom the second wager was accepted comprise distributing the progressive pot among each player from whom the second wager was accepted when the dealer's hand includes seven cards or more.

6. The method of claim 3, wherein resolving the second wager comprises determining whether the dealer holds a Blackjack and further comprising distributing the progressive pot among each player from whom the second wager was accepted when the dealer holds a blackjack.

7. The method of claim 3, further comprising taking a rake on the second wager before allocating the second wager to the progressive pot and wherein allocating the second wager to the progressive pot comprises allocating a remainder of the second wager to the progressive pot.

8. The method of claim 1, further comprising paying a payout on the first wager to the player when the Dealer hand includes a card causing a rank of the Dealer hand to exceed twenty-one.

9. The method of claim 1, wherein standing or dealing additional cards to the dealer according to house rules comprises dealing an additional card to the dealer when the dealer holds a soft seventeen.

10. The method of claim 1, wherein standing or dealing additional cards to the Dealer hand according to house rules comprises standing when the dealer holds a soft seventeen.

11. A method of administering a game of Blackjack, comprising:
accepting an ante wager from a player by receiving a physical, monetarily valuable wagering element in a designated area on a surface of a gaming table;
accepting a mandatory side wager from the player by receiving another physical, monetarily valuable wagering element in another designated area on a surface of a gaming table, the designated areas being separate and distinct from one another;
dealing two randomized physical cards from a deck of playing cards to each of a Player hand and a Dealer hand;
accepting from the player a decision to stand, in response to which no additional cards are dealt to the Player hand, or accepting a request by the player to deal at least one additional card to the Player hand, in response to which at least one additional card is dealt from the deck to the Player hand;
standing or dealing additional cards from the deck to the Dealer hand according to house rules;
resolving the side wager by determining whether the Player hand is a Blackjack;
paying a payout on the side wager to the player when the Player hand is a Blackjack by physically transferring wagering elements to the player, an amount of the payout increasing as a number of cards dealt to the Dealer hand increases; and
resolving the ante wager by comparing a rank of a hand of the Player hand to a rank of a hand of the Dealer hand.

12. The method of claim 11, further comprising collecting an amount of the side wager when the Player hand is not a Blackjack.

13. The method of claim 11, further comprising allocating an amount of the side wager to a progressive pot and maintaining the amount of the side wager in the progressive pot when the Player hand is not a Blackjack.

14. The method of claim 13, wherein paying the payout on the side wager comprises paying a portion of the progressive pot to the player controlling the Player hand having a Blackjack and allocating a remainder of the progressive pot among other players from whom a side wager was accepted during a round of play.

15. The method of claim 14, wherein paying the portion of the progressive pot to the player controlling a Player hand having a Blackjack and allocating the remainder of the progressive pot among others players from whom the side wager was accepted comprise distributing the progressive pot among each player from whom the side wager was accepted when the Dealer hand includes seven cards or more.

16. The method of claim 13, wherein resolving the side wager further comprises determining whether the Dealer hand is a Blackjack and further comprising distributing the progressive pot among each player from whom the side wager was accepted when the Dealer hand is a Blackjack.

17. The method of claim 13, further comprising taking a rake on the second wager before allocating the second wager to the progressive pot and wherein allocating the second wager to the progressive pot comprises allocating a remainder of the second wager to the progressive pot.

18. The method of claim 11, wherein standing or dealing additional cards to the Dealer hand according to house rules comprises dealing an additional card to the Dealer hand when the Dealer hand is a soft seventeen.

19. The method of claim 11, wherein standing or dealing additional cards to the Dealer hand according to house rules comprises standing when the Dealer hand is a soft seventeen.

20. A method of administering a blackjack game over a network, comprising:
receiving at a server authorization from a player to allocate funds to an ante wager;
receiving at the server authorization from the player to allocate funds to a side wager;
randomly assigning at the processor rank and suit information correlating to two cards from a deck of playing cards to a Player hand controlled by the player;
receiving at the server instructions from the player not to allocate additional cards to the Player hand, in response to which the processor does not assign rank and suit information correlating to any additional cards to the Player hand, or to allocate at least one additional card to complete the Player hand, in response to which the processor randomly assigns rank and suit information correlating to at least one additional card from the deck to the Player hand;
randomly assigning at the processor rank and suit information correlating to two cards from the deck to a Dealer hand and applying at the processor house rules to stand or randomly assign rank and suit information correlating to additional cards from the deck to complete the Dealer hand;
resolving the side wager by evaluating the Player hand at the processor to determine whether the Player hand is a Blackjack;
responsive to a determination that the Player hand is a Blackjack, authorizing at the processor payment of a payout to the player, said payout amount depending upon the number of cards allocated to the Dealer hand; and
resolving the ante wager by comparing a rank of the Player hand to a rank of the dealer hand at the processor.
